(19) United States
(12) Patent Application Publication
(10) Pub. No.: US 2005/0117870 A1
(43) Pub. Date: Jun. 2, 2005

(54) Method and system for processing background and item data for photographic files

(75) Inventor: Bor-Ying Lee, Taipei (TW)

Correspondence Address: Bor-ying Lee, P.O. Box 9-11, Neihu District, Taipei, 11499, TW

(73) Assignee: Bor-ying Lee, Taipei (TW)

(21) Appl. No.: 10/904,117

(22) Filed: Oct. 25, 2004

Related U.S. Application Data
(60) Provisional application No. 60/481,657, filed on Nov. 18, 2003.

(51) Int. Cl. H04N 9/87

(52) U.S. Cl. 386/4

(57) ABSTRACT

A system and methods for quickly entering information non-invasively for photographs stored in computer, for retrieving, displaying such information and photographs on computers and for distributing such information and photographs on digital media or through the Internet. The present invention includes computer programs, graphic user interfaces and relational databases for organizing digital collections (10) of photograph files as contents of tables in an albums relational database (16) and using simple mouse clicks to enter information about these files into tables of an arrangement relational database (31). The contents of the arrangement database and associated photograph files can be selectively retrieved for viewing using simple mouse clicks on the computer where the original digital collections reside or placed partially or in its entirety in a folder to be distributed to another computer via digital media like CD or DVD. A single photograph file together with its information can also be placed in a single steganographic file and distributed as an attachment file through any Internet email system. The present invention allows a recipient to decode the received steganographic file to view the photograph and its information. The present invention also provides method for entering master data in tables of the arrangement relational database as a prerequisite prior to entering information about photograph files. Each new entry of master data must be related to an existing master data entry.

### CROSS REFERENCE TO RELATED APPLICATIONS

This specification is based on an previously-filed provisional utility patent application 60/481657, filed on Nov. 18, 2003.

### BACKGROUND OF INVENTION

Many individuals, families, corporations and institutions hold large amount of photographic files which were either indirectly acquired by scanning traditionally printed photographs or directly captured by digital cameras or similar devices (for example cell phones with digital camera functions).

Many such collections of photographic files, saved as JPEG or other graphical file formats, lack accompanying background and item data about each photograph in said collections.

Background data are information about the time, period, location, occasion and other bits of information that shed light about a photograph.

Item data are identities of people, animal and inanimate objects on a photograph.

Together, background and item(s) data should provide a viewer with a complete frame of reference for the photograph being viewed.

Unfortunately, inputting background and item data for large collection of photograph files is a daunting task.

There are software available, for example Microsoft Photo Editor, Adobe Photoshop, for inputting said data through annotating or tagging of photograph files.

These state of the art products still exhibit the following drawbacks:

1. Annotating requires keyboard input. For large collections, such method is very time-consuming. In addition, annotation may alter the photographic image by putting text or other graphical representations on said image.

2. Tagging is better than annotating. It involves in the pre-building of master data i.e. a set of tag for names of people who might appear in a photograph collection. User can use mouse to drag tags to a photograph display for those people who appear in the said photograph.

Tagging, however, only works at the photograph file level instead of item level.

For example, if Susan and Mary appear in a photograph, the photograph file will be associated with the “Susan” and “Mary” tag, but there is no way to tell which of the 5 people on the photograph is Susan or Mary.

Tagging technique, as it stands today, does not provide relationship information.

In a family, corporation or institution collection, viewer may be also interested in the relationship between people, animal or inanimate objects, in addition to their names.

For example, if Dorothy and Toto both appear in a photograph, viewer may appreciate that Toto is Dorothy's dog or, as in the previous example, Mary is Susan's mother.

### SUMMARY OF INVENTION

The present invention resolves drawbacks associated with current state of art in processing large digital collections by utilizing relational database to store the associated background and item data.

Entry of narrative captions on a keyboard is replaced by successive mouse clicks to select pre-built masterdata which are records of tables in a relational database.

Some of these master data possess additional relationship information, thus allowing for the generation of reports that can draw inference about the organization structure of the family, organization or institution that owns the digital collection.

The source of such digital collections could be digital cameras or physical collections of photographs.

The present invention allows an user to organize a digital collection by assigning a name to a folder.

The name, the folder's full path and all the photograph files in the folder are stored in a table known as an album.

Each photograph file is also assigned an unique image number in the said album.

To add background information to a photograph file, user selects an photograph from an unprocessed album and enter data such as time, location, period, occasion and other background data on a Windows (or other GUI) screen.

Initially, an user may have to use keyboard to type in these data which will be saved as master data.

During subsequent data entry, the field's drop-down list will include the master data.

Background data are saved in background data table of a relational database known as an arrangement.

Each photograph is uniquely identified in the said table by a photo number.

Also saved is the album name and the image number.

The present invention allows an user to enter item data by mouse-clicking an item, be it a person, an animal or an inanimate object.

The item's name and its position on the photograph will be saved in an item data table which contains all items of an arrangement.

An item's name has to be pre-built and saved in a master data table to appear as an selectable option in a drop-down list. Relationship data must also be entered to allow user viewing, report and caption generation.

To view the entered background and item data, an user first makes use of a filter, made up of background data and any item name, to focus on a target group of photographs to view.

The targeted photographs are shown as a list and an user can mouse-click any entry in the list to view a photograph and its background data.

To view item data, an user can either use the left mouse button (sequential viewing) or the right mouse button (random viewing).

Once a digital collection has been completely processed, an user might export all or part of the arrangement to another party.

The present invention proposes two methods of export: batch export through CD or DVD and singular export through email.

When exporting a single photograph, the present invention combines both photograph and its background and item data into one file with a special file extension.

The recipient, with a thin client properly installed, can simply double click the received file to open it for viewing, similar to double clicking on an PDF file to bring up the Acrobat Reader.

The received file can also be merged into an existing arrangement on the recipient's computer.

### BRIEF DESCRIPTION OF DRAWINGS

FIG. 1 presents an example of a digital collection and arrangement.

FIG. 2 presents an example of inputting background data.

FIG. 3 present an example of inputting item data.

FIG. 4 present an example of filtering, viewing and editing of photographs in an arrangement.

FIG. 5 present an example of batch exporting an arrangement.

FIG. 6 present an example of exporting a single photograph from an arrangement.

### DETAILED DESCRIPTION

Glossary of terms and acronyms.

Album. A table in an album database. Each record in an album contains an unique image number and the name of a photograph file. Other information regarding the photograph file may also be stored in the record e.g. indicator if it has been added to an arrangement, indicator if its color or black/white etc.

Albums. An relational database that contains albums and an album list. Each album is uniquely named and has a corresponding entry in the album list.

Album list. A table in an album database. Each record in an album list contains the name of an album and the full path of a folder that holds photograph files.

Arrangement. A relational database that holds tables for background data, item data and master data.

Background Data. A table in an arrangement. Each record in a background data contains an unique photo number, album, image number and fields for period, location, occasion etc.

Digital Collection. Folders on a computer containing JPEG or other graphical format files are collectively known as a digital collection.

Item Data. A table in an arrangement. Each record in an item data contains an photo number, an item number and fields for storing the coordinates of the item in the photograph.

Master Data. A table in an arrangement. There could be multiple tables for master data, each table containing one type of master data. For example, people, location, animal, periods are all associated with a data. Each master data record contains at least an unique name. Some master data table requires additional relationship data.

Physical Collection. Photographs stored in physical albums, envelopes, desk drawers etc. in a family, corporation or institution are collectively known as a physical collection.

The present invention resolves drawbacks associated with current state of art in processing digital collections with large amount of photographic files by utilizing relational database to store the associated background and item data for said files.

Time-consuming entry of narrative captions on a keyboard is replaced by successive mouse clicks to select pre-built or build-as-you-go master data from drop-down lists which are fields of tables in a relational database.

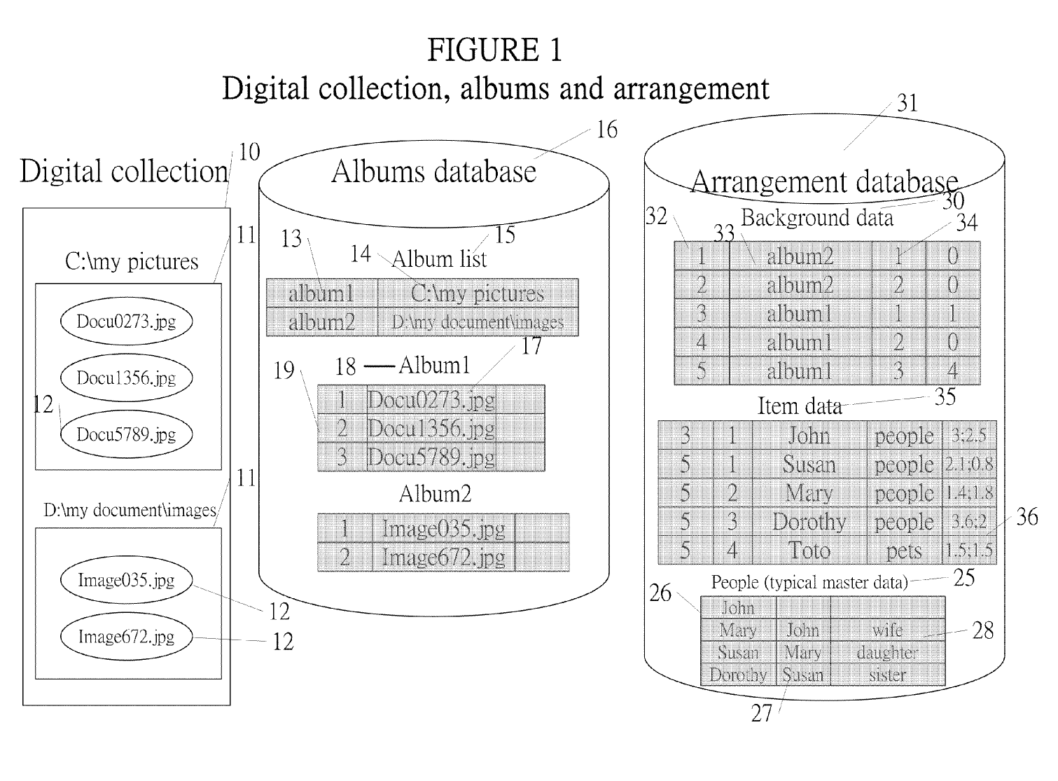

Normally a digital collection of photographs 10 exist on a computer as one or more folders 11 containing JPEG or other graphical format files 12, shown in FIG. 1.

The division of files into folders may be arbitrary or based on simple rules of thumb. For example, scanned photograph files may be placed in the same folder if they originated from the same physical album. For photograph files captured by digital cameras, photograph files in a folder may come from the same upload batch.

The present invention allows an user to organize a digital collection by assigning a name to a folder.

The name 13, the folder's full path 14 are stored in an album list table 15 of an relational database known as albums 16.

All the photograph files 17 in the folder are stored in an album table 18 of the albums database.

There could be multiple album tables in an albums database.

Each photograph file is also assigned an unique serial number in the said album, known as image number 19.

The association of a logical album with a physical folder allows implementation of the present invention to add and store background and item data for photograph files in an non-invasive manner i.e. the photograph files themselves are not altered.

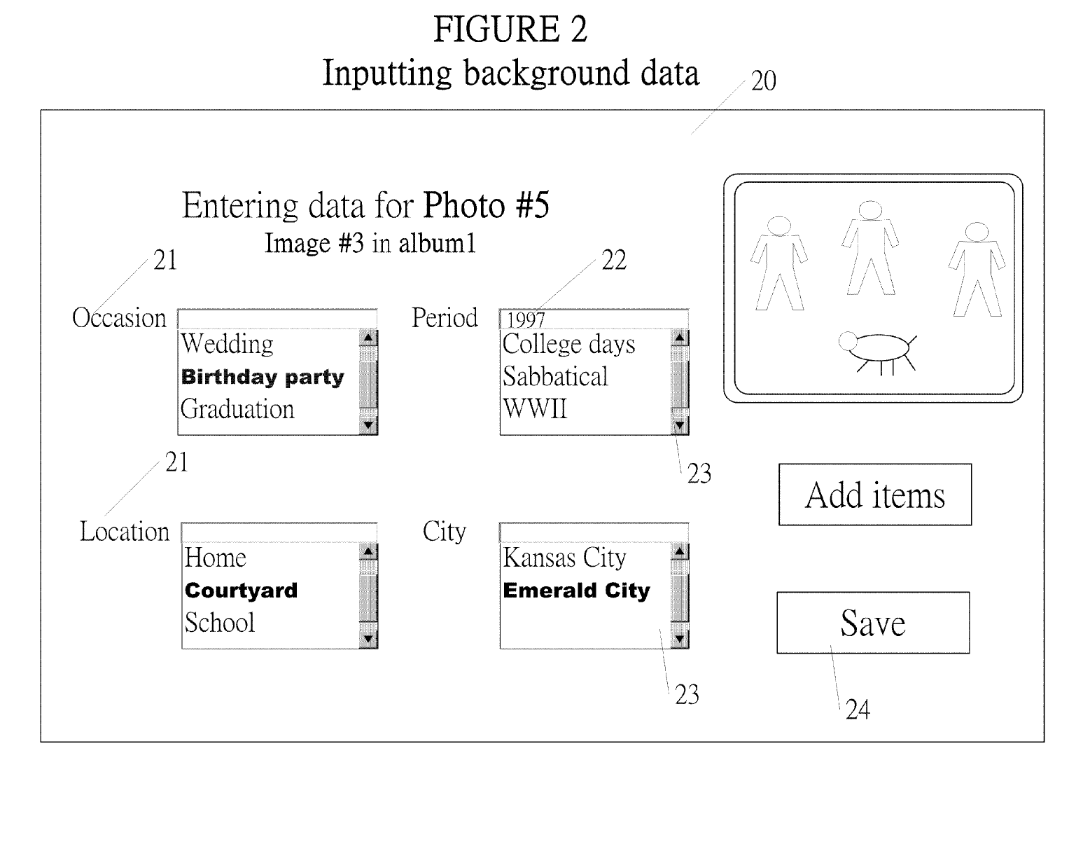

To add background information to a photograph file, shown in FIG. 2, the present invention allows an user, through graphical user interfaces 20, to select an unprocessed or partially-processed album.

Each unprocessed photograph will be presented to the said user on the screen along with fields 21 to enter data such as time, location, period, occasion and other background data. Initially, an user may have to use keyboard to type in these data 22.

But once data is entered into a field, it will be saved as master data. When next photograph appears, the corresponding field will feature a drop-down list 23 which will include the previously keyed-in data.

This way, as an user progresses into the processing of a digital collection, less and less data will be keyed in as more master data would be built up and appear in drop-down lists, allowing an user to simply mouse-click a selection.

Once the background data is entered, an user can mouse-click the Save button 24 to save the said data in a background data table 30 in a relational database known as an arrangement 31, shown in FIG. 1.

Each photograph is uniquely identified in the said table by a serial number known as photo number.

Also saved are the name of the album 33 that the photograph belongs and its image number 34.

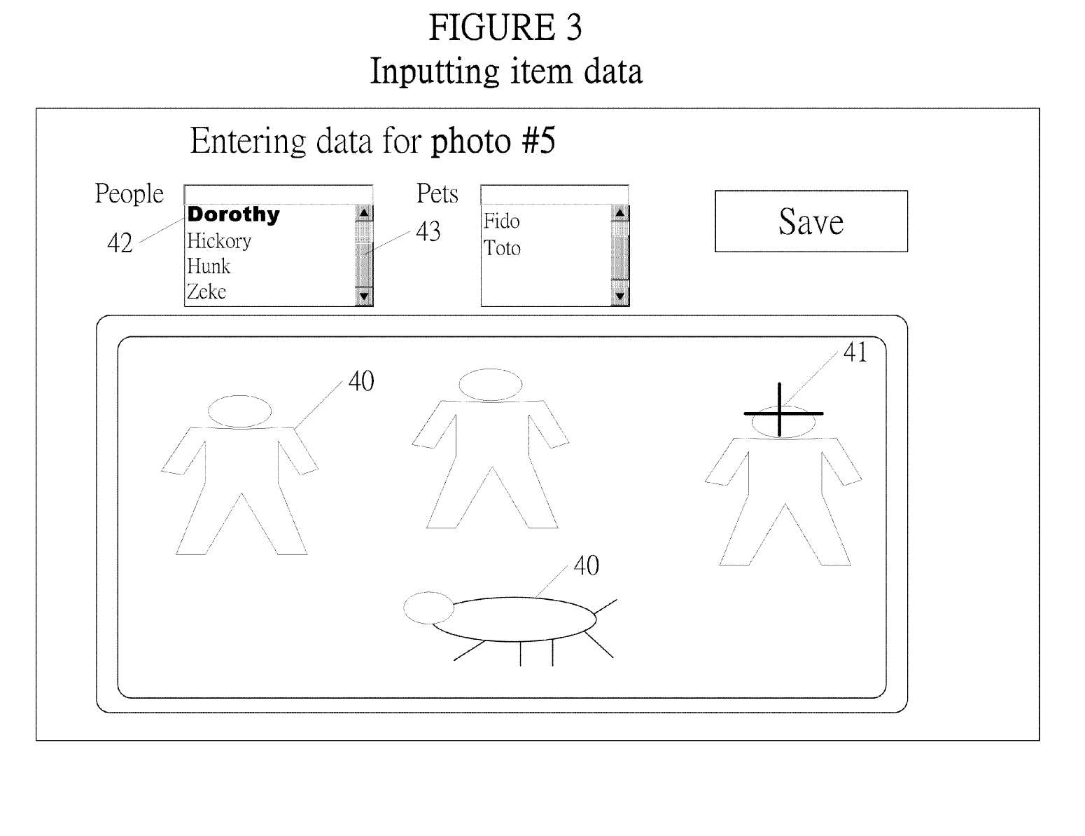

Following the entry of background data, an user can immediately proceed to enter item data, shown in FIG. 3.

The present invention allows an user to mouse-click once anywhere on an item, be it a person, an animal or an inanimate object 40.

A special icon 41 will appear on the spot where the mouse was clicked. Then the user can select a name 42 from an appropriate drop-down list 43.

The item's coordinate 36 will be saved, as shown in FIG. 1, in an item data table 35 which contains all items 36 of an arrangement.

For example, an user can move the cursor to Susan's face and then mouse-clicks at the spot. The user then clicks the drop-down list for people and selects Susan by mouse-clicking on the name Susan.

The inputting of item data is entirely through mouse-clicking.

To allow users to simply use mouse-click to enter item data requires an user to pre-build the master data for items.

The names of people, animals and inanimate objects are first entered by keyboard and stored in different master data tables 25 in an arrangement.

Each record in a master data table corresponds to one name 26. For example, the people table will have records for Susan, Mary, Dorothy etc. The animal master data will have records for Toto, Fido etc.

Along with names, the present invention also requires an user to enter relationship data for each record. For example, in the record for Mary, the user must indicate who is Mary related to (John) 27 and the relationship (wife) 28.

The present invention allows master data to be pre-built through screens with graphical user interfaces.

The “related to” field will also contain a drop-down list of people and the user can only select one name from the said list.

This means that when entering an new name, it must be related to an existing name. This requirement further means there is a “root” or the very first master data record where the “related to” field is impossible to fill. The present invention requires an implementation to hard-code this exception case.

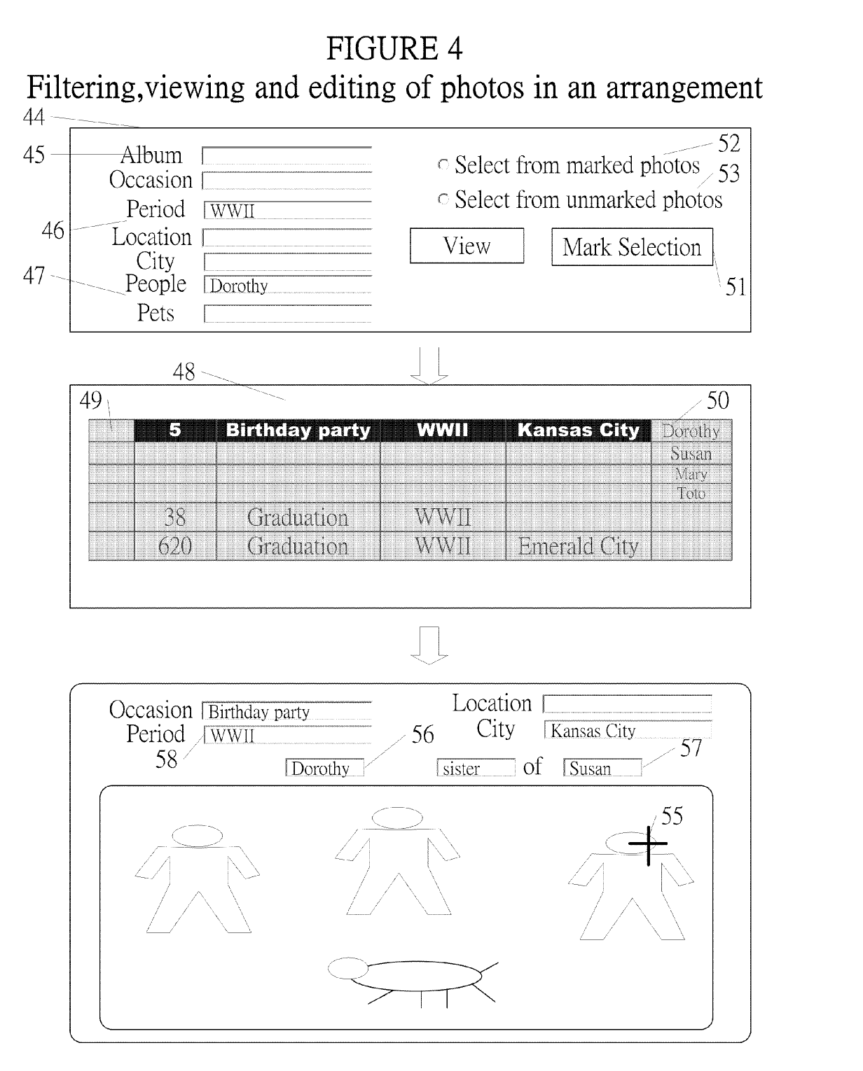

To view the entered background and item data, the present invention allows an user, as shown in FIG. 4, through graphical user interfaces, builds up an filter 44 first.

The filter will let an user specify any album 45, any of the background data 46 and any item name 47 as selection criteria for data in an arrangement.

This allows an user to focus on a smaller set of photograph in a large arrangement.

Since the number of items on a photograph is variable, to select more than one item name in a category, for example people, the present invention uses an marking scheme to represent the ANDing and ORing of item names.

Once the filter is built, the present invention will present a filtered list 48 containing all photographs that meet the selection criteria.

Each line in a filtered list corresponds to a photograph and displays some summary information, for example, thumbnail image of a photograph 49, its location, period and names of items 50 on the photograph.

Hyperlinks will be placed on the thumbnail image field to allow user to view a full screen initially containing the selected photograph and all the background data fields.

The marking scheme allows an user to mark all items 51 in a filtered list instead of displaying it.

Use can then return to the filter screen and specify that the selection criteria to be built will be applied only to the filtered list (those that are marked) 52.

This time, user can select another item name. The resultant filtered list will be the ANDing of the first selection criteria and the second selection criteria. This process can repeated as many times as an user wishes, until the filtering of item names is completed.

Similarly, an user can also specify that the selection criteria to be built will be applied only to those photographs that are not marked 53.

The resultant filtered list will be the ORing of the first selection criteria and the second selection criteria.

To view item data, an user can either use the left mouse button or the right mouse button.

By clicking on the left mouse button, a special icon 55 will appear at the spot where the item data was originally entered. Item's name 56 will appear in a special field on the screen, along with its relationship data 57.

The name is hyperlinked to another screen where the master data associated with the name are presented.

Successive clicking of the left mouse will present additional items until all items data are presented.

This mode is appropriate when there are only a few items on a photograph.

In a large gathering like graduation photograph where many items may appear, the present invention allows an user to right mouse-clicks anywhere on the photograph and all item will be marked by special icons at the spots where their data were originally entered.

The user then moves the cursor to any of the icon and the associated item name will appear in a special field on the screen.

The name is similarly hyperlinked as in the case of the left mouse-click.

The present invention also allows an user to edit background and item data already entered for a photograph as shown in FIG. 4.

An user would select the photograph or photographs to edit by using the filter 44 the same way as viewing.

Once the editing screen is presented, an user can alter any background data fields 58 by making another selection from the associated drop-down list or key in brand new data.

Editing item data also involves two modes: the left mouse button to add new item and the right mouse button to delete an existing item.

The left mouse button is used exactly the same way as entering new item data as previously described.

Clicking the right mouse button will have cause all items to be exposed with special icons 55.

By moving the cursor to an icon, the item associated with the icon is removed from the item data table.

Once a digital collection has been completely processed, an user might export all or part of the arrangement to another party.

The present invention proposes two methods of export: batch export and singular export.

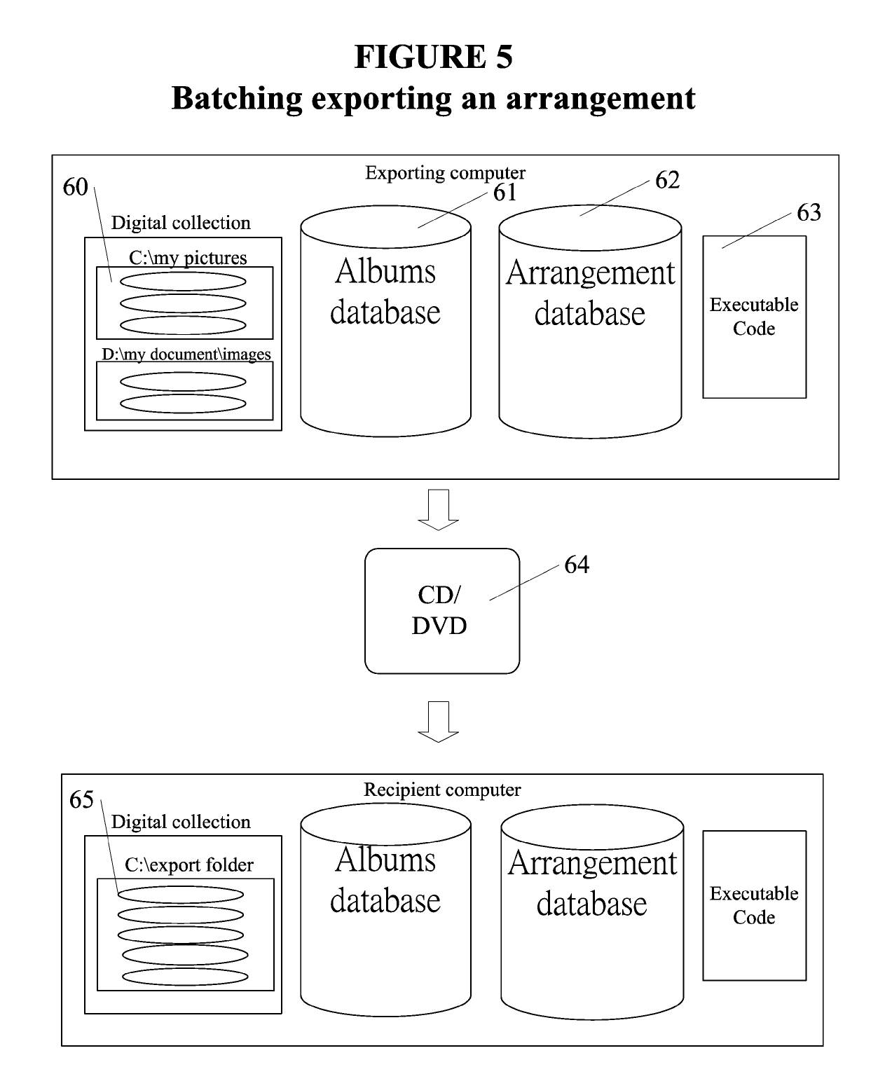

Batch export is used for exporting large amount of photographs through CD or DVD or other storage medium, as shown in FIG. 5.

In this mode, all selected photograph files 60, along with albums 61 and arrangement 62 databases , as well as the executable code 63 are copied to a specified folder which serves as a CD image.

Any commercially available CD or DVD burning program can then be used to copy and burn the data in the CD image onto a CD or DVD 64.

The authorized recipient of the said CD or DVD can then copy its content into a folder 65 on a compatible computer and start the viewing program and any other authorized activities.

The recipient will be able to view photograph files along with their associated background and item data by using the same method as previously described in viewing and other activities.

The batch export provides the recipient with a rich client where all the activities of the present invention are available, subject to authorization.

Sometimes, the recipient may only need to view photographs. For example, parents may occasionally send family photographs to children away in college. In such cases, the recipient only needs to install a thin client of the present invention with only the viewing activity available.

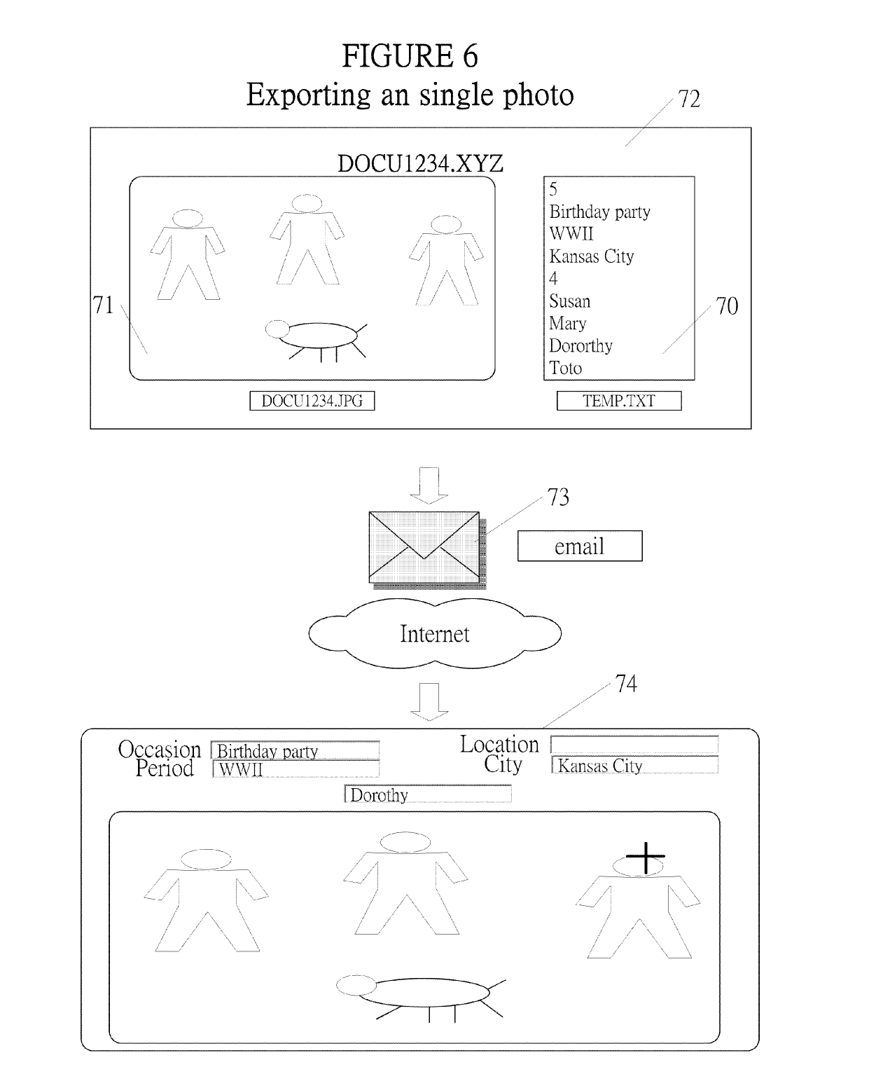

When exporting a single photograph file with its background and item data, the present invention, as shown in FIG. 6, saves the said data in a text file 70.

Then the text file is either embedded in the photograph file 71 steganographically (refer to US Patent Application #20020051162 which deals with steganography applied to printed matter) or through other embedding or appending technique (refer to US Patent Application # 20030098877 which deals with attaching information by extending a JPEG file).

The resulting file, containing both the photograph file and the text file, is saved with a different extension. For example, the original DOCU0012.JPG file, once embedded with text data, is saved as DOCU0012.XYZ.

This file can then be sent to the recipient via normal email 73 as an attachment file.

Once the recipient receives the email and saves the attached file in a folder, he/she can simply double-click on the file to bring up the photograph screen along with all the background data.

Items data can then be shown using either the left mouse button or the right mouse button as previously described.

In addition, such singular export can have optional password and additional short secret message attached. The saved file 72 will have a different extension, for example DOCU0012.XZZ. The recipient will need to provide a password before the secret message is shown.

To enable double clicking an singularly exported photograph file for viewing 74, the recipient will have to install the thin client on his/her computer in such a way to associate the file extension (for example XYZ, XZZ) with the thin client. This is similar to double clicking on an PDF file to bring up the Acrobat Reader program.

If the recipient also has the rich client installed, either through batch export or because the recipient needs to process his/her own digital collections, the present invention allows the singularly exported file to be added to the recipient's arrangement.

The photograph file and the embedded background and item data will be added to the associated tables of the said arrangement.

The present invention allows an user to request reports based on the data present in an arrangement.

Since item names are related, user can request, for example, a family tree report based on the people data in a family arrangement.

In corporation or institution arrangements, user can request organizational or hierarchical reports, along with photographs of people in the hierarchy or organization.

Such reports can be based on static hierarchical definitions or can be derived ad hoc.

During printing of a photograph from an arrangement, caption can also be automatically synthesized by combining various background data fields based on certain grammatical rules.

1. A method for organizing digital collections comprised of photograph files into tables of a relational database known as albums

2. A method for quickly adding background and item data non-invasively using only mouse clicks for said digital collections into tables of a relational database known as arrangement.

3. A method for selectively retrieving subsets of said digital collections and corresponding data from said databases for display using only mouse clicks.

4. A method for creating and maintaining master data in tables of arrangement database to facilitate quick entry of item data.

5. A method for automatically creating master data in tables of arrangement database to facilitate quick entry of background data.

6. A method for maintaining tables of digital collections described in claim 2.

7. A method for maintaining tables of background and item data described in claim 3.

8. A method for transferring all or part of said digital collections, associated background and item data saved in said databases and corresponding programs into a separate folder for burning onto a CD, DVD or other such digital media.

9. A method for merging a singular photograph file in said digital collections, its associated background and item data and a message into a steganographically composed file for transmission to an recipient through the Internet via normal email as an attachment file.

10. A method for decomposing said steganographically composed file to display the original photograph file, associated background and item data and the said message.

11. The method according to claim 2 further comprises an user interface to allow an user to specify the path of a folder containing digital collections of photograph files in JPEG format.

12. The method according to claim 2 further comprises the saving of the path described in claim 12 and an unique name entered by the said user in a record in the album list table of the albums database described in claim 2.

13. The method according to claim 2 further comprises the creation of an empty table using the unique name described in claim 13 in the albums database.

14. The method according to claim 2 further comprises the saving of the name of each photograph file described in claim 12 and an unique serial number known as image number in a record in the table described in claim 14 in the albums database.

15. The method according to claim 3 further comprises an user interface to allow an user to select an table described in claim 15 and displays each photograph file sequentially as on a computer display.

16. The method according to claim 3 further comprises an user interface to allow an user to enter background data such as location, time, period and occasion in text fields on a computer display by selecting one entry from accompanying drop-down lists of master data using mouse clicks or typing the relevant data using keyboard if no desired entry is listed.

17. The method according to claim 6 further comprises the creation of master data using the background data entered by typing from keyboard as described in claim 17 and saving said master data in specific tables in the arrangement database.

18. The method according to claim 3 further comprises the display of the background data so entered as described in claim 17 as default entry when next photograph file from the same table as described in claim 16 is processed.

19. The method according to claim 3 further comprises the saving of the background data along with an unique serial photo number, the name of the table as described in claim 16 and the image number of the photograph file as described in claim 15 in a record in the background data table of the arrangement database.

20. The method according to claim 3 further comprises another user interface to allow an user to click the left mouse button to select an item (person, animal or inanimate object) anywhere on the displayed image and then click the left mouse button to select an entry from a drop-list of master data as described in claim 5.

21. The method according to claim 21 further comprises the saving of the selected master data, the coordinates of the mouse click on the said image as described in claim 21, an unique serial item number and the photo number as described in claim 20 in a record in the item data table of the arrangement database.

22. The method according to claim 3 further comprises the repeat of the process as described in claim 21 and 22 for all other items on the said image.

23. The method according to claim 5 further comprises an user interface to allow an user to create master data for items during the process as described in claim 21 or at any another time (e.g. before the start of process as described in claim 21) by entering an unique nick name, a corresponding formal name (for people master data only) and selecting, via mouse click , an existing item from a drop-down list of existing master data and the type of relationship to the selected item (for people master data only).

24. The method according to claim 24 further comprises the saving of the new master data in a record in one of the master data tables (people, animals, inanimate objects) in the arrangement database.

25. The method according to claim 5 further comprises an user interface to allow an user to modify or delete an existing record created in the manner described in claim 24.

26. The method according to claim 4 further comprises an user interface to allow an user to specify, via mouse click on a drop-down list, any table as described in claim 15, to optionally specify certain items (people, animals, inanimate objects) and to optionally specify certain values for some of the background data fields to construct a filter.

27. The method according to claim 4 further comprises the retrieval of photograph files and and associated background and item data from databases by using the filter constructed in claim 27 and the display of the relevant information like photo number, number of items and the nick names of the items for an photograph file in a list on a subsequent computer display.

28. The method according to claim 4 further comprises an user interface to allow an user to use mouse click to select an photo number on the said list described in claim 28.

29. The method according to claim 29 further comprises the retrieval and display of the associated image and background data on a subsequent computer display.

30. The method according to claim 4 further comprises an user interface for an user to click the left mouse button to retrieve and displays each of the items on the displayed image as described in claim 30 in succession by displaying a special icon on an item and the related item data in the margin area of the computer display described in claim 30.

31. The method according to claim 4 further comprises an user interface for an user to click the right mouse button to retrieve and displays all items together on the displayed image as described in claim 30 by displaying a special icon on each item.

32. The method according to claim 32 further comprises the determination of the cursor position to any of the displayed icons as described in claim 32 to retrieve and display the related item data in the margin area of the computer display described in claim 30.

33. The method according to claim 7 further comprises the use of a filter in the same manner as described in claims 27, 28, 29 and 30 to allow an user to select an image to maintain its background data.

34. The method according to claim 7 further comprises an user interface to allow an user to add item data to the selected image as described in claim 34 by using the left mouse button as described in claims 21, 22 and 23.

35. The method according to claim 7 further comprises an user interface to allow an user to delete item data of the selected image as described in claim 34 by clicking the right mouse button on the image.

36. The method according to claim 36 further comprises the retrieval and display of all items together on the displayed image as described in claim 34 by displaying a special icon on each item.

37. The method according to claim 36 further comprises the determination of the cursor position to any of the displayed icons as described in claim 37 to delete the related item data record from the item data table of the arrangement database.
